(19) United States
(12) Patent Application Publication
(10) Pub. No.: US 2025/0164865 A1
(43) Pub. Date: May 22, 2025

(54) ELECTRONIC APPARATUS AND ACCESSORY APPARATUS

(71) Applicant: CANON KABUSHIKI KAISHA, Tokyo (JP)

(72) Inventors: HIDETOSHI KEI, Tokyo (JP); TAKAZUMI SEO, Tokyo (JP); TOMOKO MORI, Kanagawa (JP)

(21) Appl. No.: 18/925,541

(22) Filed: Oct. 24, 2024

(30) Foreign Application Priority Data
Nov. 21, 2023 (JP) 2023-197198

(51) Int. Cl. G03B 17/56; F16M 13/02

(52) U.S. Cl. CPC G03B 17/566; F16M 13/02; G03B 17/561; G03B 17/563

(57) ABSTRACT

An electronic apparatus includes a tightening member having a first screw engagement portion and a first lock portion. The electronic apparatus is configured to allow for attachment and detachment of an accessory apparatus, which includes a rotation locking member having a second lock portion that rotates around a central axis of the tightening member and that engages with the first lock portion, and the tightening member is positioned coaxially with the first screw engagement portion and is provided outside the first screw engagement portion but inside the electronic apparatus.

### BACKGROUND

### Technical Field

One of the aspects of the embodiments relates to an electronic apparatus including a mounting structure for attaching and detaching an accessory.

### Description of Related Art

An electronic apparatus, such as a digital camera, can be used to attach a wide variety of accessories to a tripod screw on a bottom surface of the camera. While the tripod screw is highly versatile, fixing the camera with it requires either turning the screw on the accessory or rotating the camera itself, which makes attachment and detachment time-consuming. Japanese Patent No. 4518039 discloses an accessory that simplifies attachment and detachment to a compatible accessory body by attaching an attachment to the bottom surface of the camera.

The accessory described in Japanese Patent No. 4518039 requires the attachment to be attached to the bottom surface of the camera, which increases the camera's size and impairs its portability. Additionally, if an accessory that is not compatible with the attachment needs to be used, removing the attachment can be time-consuming, making process of attaching and detaching the accessory lengthy.

### SUMMARY

An electronic apparatus according to one aspect of the present disclosure includes a tightening member including a first screw engagement portion and a first lock portion. The electronic apparatus is configured to allow for attachment and detachment of an accessory apparatus, which includes a rotation locking member having a second lock portion that rotates around a central axis of the tightening member and that engages with the first lock portion, and the tightening member is positioned coaxially with the first screw engagement portion and is provided outside the first screw engagement portion but inside the electronic apparatus.

Further features of various embodiments of the disclosure will become apparent from the following description of exemplary embodiments with reference to the attached drawings.

### BRIEF DESCRIPTION OF THE DRAWINGS

FIGS. 1A, 1B, and 1C are diagrams illustrating appearance of a camera, which is an electronic apparatus, according to first embodiment.

FIGS. 2A, 2B, and 2C are diagrams illustrating a bayonet tightening portion according to the first embodiment.

FIGS. 3A and 3B are diagrams illustrating appearance of a grip accessory according to the first embodiment.

FIGS. 4A and 4B are diagrams illustrating a platform according to the first embodiment.

FIGS. 5A, 5B, 5C, and 5D are diagrams illustrating operation of internal parts of the platform when the camera and the grip accessory are attached, according to the first embodiment.

FIGS. 6A, 6B, 6C, 6D, and 6E are diagrams illustrating operation of a bayonet member when the camera and the grip accessory are attached during a mounting phase, according to the first embodiment.

FIGS. 7A, 7B, 7C, and 7D are diagrams illustrating operation of the bayonet member when the camera and the grip accessory are attached during a non-mounting phase, according to the first embodiment.

FIGS. 8A, 8B, and 8C are diagrams illustrating a method of mounting a grip accessory to a camera not equipped with a bayonet tightening portion, according to the first embodiment.

FIGS. 9A, 9B, and 9C are diagrams illustrating a bayonet tightening portion according to second embodiment.

FIGS. 10A, 10B, 10C, and 10D are diagrams illustrating appearance of a camera according to third embodiment.

FIGS. 11A, 11B, and 11C are diagrams illustrating a platform according to the third embodiment.

FIGS. 12A, 12B, 12C, and 12D are diagrams illustrating operation of internal parts of the platform when the camera and grip accessory are attached, according to the third embodiment.

FIGS. 13A, 13B, 13C, 13D, and 13E are diagrams illustrating operation of a bayonet member when the camera and the grip accessory are attached during a mounting phase, according to the third embodiment.

FIGS. 14A, 14B, and 14C are diagrams illustrating appearance of a camera according to fourth embodiment.

FIGS. 15A, 15B, and 15C are diagrams illustrating a locking claw tightening portion according to the fourth embodiment.

FIGS. 16A, 16B, and 16C are diagrams illustrating a platform according to the fourth embodiment.

FIGS. 17A and 17B are diagrams illustrating a locking member according to the fourth embodiment.

FIGS. 18A and 18B are diagrams illustrating a structure of the platform according to the fourth embodiment.

FIGS. 19A, 19B, 19C, 19D, and 19E are diagrams illustrating operation of a locking mechanism when a camera is attached to the platform, according to the fourth embodiment.

### DETAILED DESCRIPTION

Referring now to the accompanying drawings, a detailed description will be given of examples according to the disclosure. Corresponding elements in respective figures will be designated by the same reference numerals, and a duplicate description thereof will be omitted.

### First Embodiment

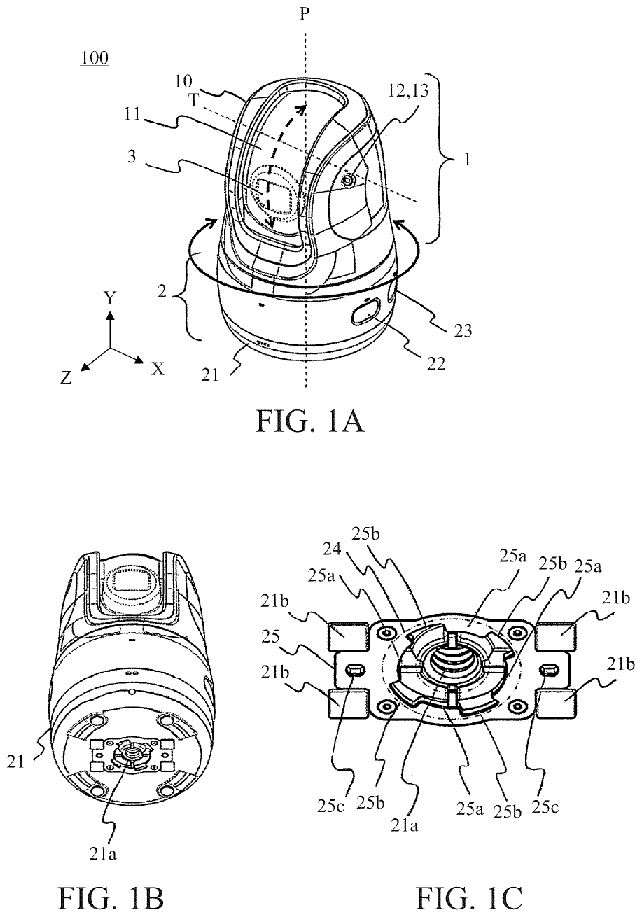

FIGS. 1A, 1, and 1C are diagrams illustrating appearance of a camera 100, which is an example of an electronic apparatus according to this embodiment. FIG. 1A is a front perspective view of the camera 100, FIG. 1B is a bottom perspective view of the camera 100, and FIG. 1C is an enlarged view of a bayonet tightening portion (tightening member) 24. In this embodiment, the camera 100 that holds a lens unit 3 to be capable of tilting rotation and panning rotation will be described as an example of the electronic apparatus, but the present disclosure is also applicable to other apparatuses.

The camera 100 has a first housing 1 and a second housing 2. The first housing 1 is installed on a top of the second housing 2 and is held to be capable of horizontal rotation (panning: rotation in a direction of a solid arrow) around an axis P relative to the second housing 2. The top cover 10 is an exterior part of the camera 100, is formed of a transparent material, and includes a dome member 11 that covers a front part and a top part. The dome member 11 is formed of a transparent resin material such as a polycarbonate resin or an acrylic resin. Inside the dome member 11, the lens unit 3 illustrated by a dashed line is held to be capable of vertical rotation (tilting: rotation in a direction of a dashed arrow) perpendicular to a horizontal rotation direction around an axis T. With the above configuration, the camera 100 can move the lens unit 3 relative to the second housing 2 by appropriately combining panning and tilting, and even if the camera 100 is placed at a fixed point, it is possible to take pictures in various directions.

The second housing 2 is an exterior component of the camera 100, and includes a bottom cover (exterior member) 21 that forms part of an appearance surface of the camera 100. A control board, a driving battery, and a wireless module (not illustrated) are arranged inside the bottom cover 21. A power button 22 and a wireless communication button 23 are provided on a side surface of the bottom cover 21. In addition, a female screw portion (first screw engagement portion) 21a, which screws into a male screw portion of a universal camera accessory, is formed (integrally molded) on a bottom surface of the bottom cover 21. The bayonet tightening portion 24 corresponding to a bayonet member (rotation locking member) 556 of a grip accessory (accessory apparatus) 500 (described later) is provided around the female screw portion 21a. The bayonet tightening portion 24 includes the bottom cover 21 and a mount member 25 fastened to the bottom cover 21 with a screw, and is positioned coaxially with the female screw portion 21a. The mount member 25 is a component that is manufactured by pressing a metal plate and that becomes a structural body when fastened to the grip accessory 500, and is a member having high rigidity and strength. The mount member 25 is provided with an opening centered on the female screw portion 21a. The mount member 25 also includes a plurality of mount claw portions (first lock portion) 25a and a mount concave portion 25b. The mount claw portion 25a is formed by extending from the mount member 25 toward a center of the female screw portion 21a. The mount concave portion 25b is a notch portion provided between the plurality of mount claw portions 25a. Thus, the mount concave portion 25b is recessed outward from the mount claw portion 25a in a radial direction centered on the female screw portion 21a. An area of the bayonet tightening portion 24 is outside the female screw portion 21a and inside an outer shape of the mount concave portion 25b.

In addition, the mount member 25 is formed with a pair of lock grooves (hole portions) 25c into which a pushpin 557 of the grip accessory 500, which will be described later, fits. When the camera 100 and the grip accessory 500 are attached (hereinafter simply referred to as the attached state), the pushpin 557 fits into the lock groove 25c, thereby restricting the rotation of the camera 100 relative to the grip accessory 500. The pair of lock grooves 25c are centered on the female screw portion 21a and are disposed opposite each other on the X-axis outside the mount concave portion 25b. Additionally, the pair of lock grooves 25c are formed on the same plane as the bayonet tightening portion 24 and outside the outer shape of the bayonet tightening portion.

The bottom cover 21 has four contact surfaces 21b that come into contact with the grip accessory 500. The contact surfaces 21b are symmetrically arranged on both sides in the Z-axis direction with the pair of lock grooves 25c at the center. In the present embodiment, the mount member 25 and the bottom cover 21 are separate components, but the shape of the mount member 25 may be integrally formed with the bottom cover 21.

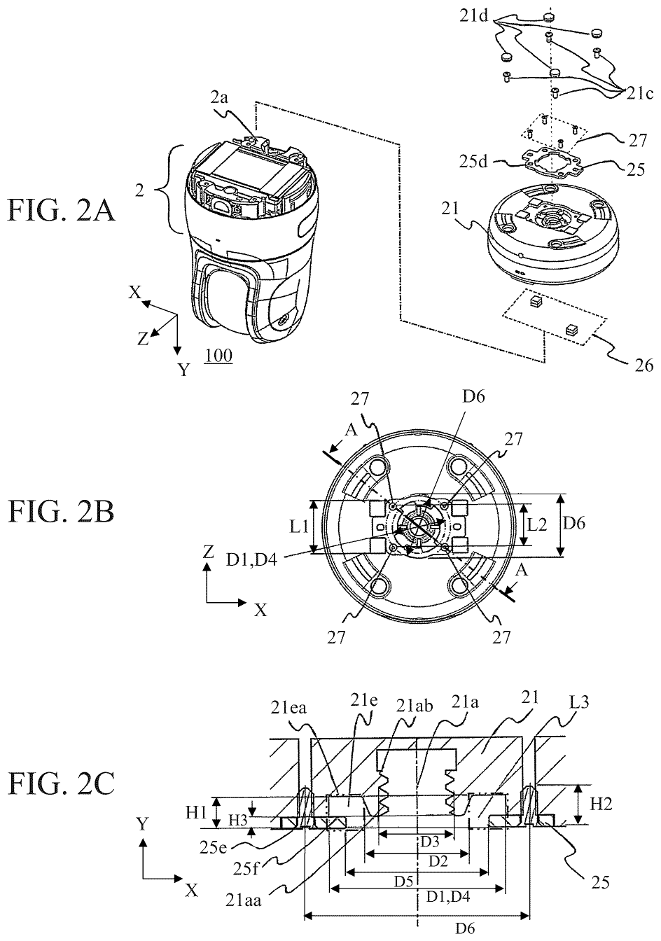

FIGS. 2A, 2B, and 2C are diagrams illustrating the bayonet tightening portion 24. FIG. 2A is an exploded perspective view of the bayonet tightening portion 24. The magnet 26 provides suction and adsorption forces to the camera 100 and the grip accessory 500. The magnet 26 is assembled directly below the contact surfaces 21b from the inside of the bottom cover 21 made of a resin material, and is fixed by an adhesive. The mount member 25 is fixed to the bottom cover 21 by four screws 27 arranged on the outside of the bayonet tightening portion 24. The screws 27 are countersunk screws. The screw hole portion 25d of the mount member 25 is provided with a chamfered shape corresponding to the neck taper shape of the screw 27. As a result, the neck taper shape and the chamfered shape are in contact with each other at an inclined surface when the screw is fastened, reducing positional deviation due to dropping or impact, and the screw head does not protrude from the surface 25e of the mount member 25. The bottom cover 21 is fixed with four screws 21c to a main base 2a molded from a resin material that serves as the foundation of the second housing 2. Cushion members 21d are cushioning parts that serve as legs supporting the camera 100, and are attached directly above the four screws 21c.

FIG. 2B is a bottom view of the camera 100, and FIG. 2C is a cross-sectional view along the line A-A in FIG. 2B. Here, the size of the radial direction (X-axis direction and Z-axis direction) of the bayonet tightening portion 24 will be described. The outer diameter D1 of the bayonet tightening portion 24 becomes the diameter D4 of the mount concave portion 25b. The female screw portion 21a is formed with a standardized unified screw nominal of ¼, and the thread root diameter D3 is determined. The inner diameter D2 of the bayonet tightening portion 24 is larger than the thread root diameter D3 to ensure that the female screw portion 21a has a wall thickness to satisfy the required strength. The diameter D5 of the mount claw portion 25a is approximately the average diameter of the outer diameter D1 and the inner diameter D2 of the bayonet tightening portion 24. The maximum outer diameter D6 of the mount member 25 is larger than the diameter D4 of the mount concave portion 25b to ensure a wall thickness that can be pressed and ensures strength. The screws 27 are arranged on a circumference of the maximum outer diameter D6 of the mount member 25, but are not spaced at equal intervals, and are arranged so that the spacing L2 between the screws 27 in the Z-axis direction is more inward than the maximum outer diameter D6. The contact surfaces 21b are arranged so that the spacing L1 between the contact surfaces 21b is more inward than the maximum outer diameter D6. With the above configuration, the screws 27 and the contact surfaces 21b can be arranged in the Z-axis direction even in a slim camera.

Next, the size of the bayonet tightening portion 24 in the height direction (Y-axis direction) will be explained. The height H1 of the bayonet tightening portion 24 is the distance from the surface 25e of the mount member 25 to the bottom surface 21ea of the bayonet claw holder 21e, which is formed around the female screw portion 21a. The screw 27 is used when fastening the mount member 25, and a sufficient screw engagement length is required to prevent damage or loosening of the screw tightening portion when external force is applied to the mount member 25. In other words, the height H2 from the surface 25e of the mount member 25 to the tip of the screw must be a certain height. By setting the height H1 of the bayonet tightening portion 24 lower than the height H2, which is determined by the screw engagement length of the screw 27, the bayonet tightening portion 24 can be positioned in a compact camera along the Y-axis direction. Moreover, by forming the tip 21aa of the female screw hole at a recessed position H3 relative to the surface 25e of the mount member 25, the gap L3, which allows for the insertion of the bayonet claw portion (second lock portion) 556b, can be increased. The position H3 of the tip 21aa of the female screw hole portion is set based on the back surface 25f of the mount member where the bayonet claw portion 556b engages. With this configuration, even if the thickness necessary to meet the required strength of the bayonet claw portion 556b is ensured, the diameter D5 of the mount claw portion 25a can be reduced.

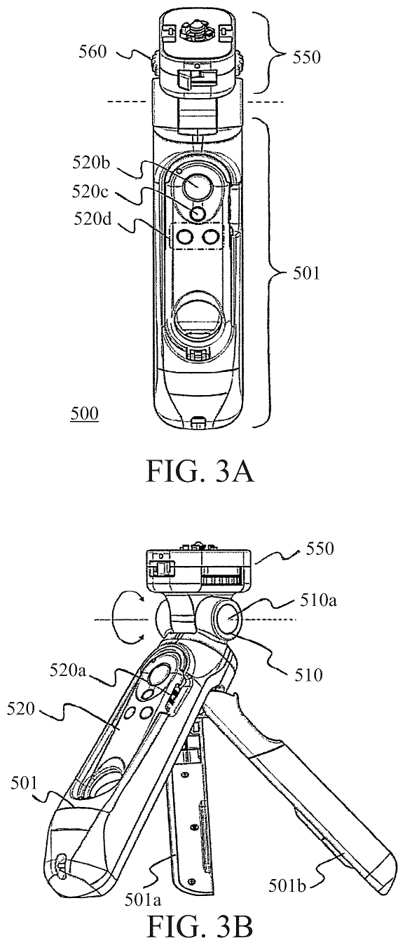

FIGS. 3A and 3B are diagrams illustrating appearance of the grip accessory 500 according to the first embodiment. FIG. 3A is a front perspective view of the grip accessory 500, and FIG. 3B is a perspective view of the grip accessory 500 when used as a tripod.

The grip accessory 500 is attached to the bayonet tightening portion 24 provided on the bottom surface of the camera 100. The user grips the main body of the grip body 501 to take photos. The grip accessory 500 includes a grip body 501, which is of a thickness that allows the user to hold it with one hand, and a platform 550, to which the camera 100 is fixed. The grip body 501 and the platform 550 are connected by a link portion 510. By pressing the lock release button 510a, which is positioned at the center of the link portion 510, the platform 550 can rotate relative to the grip body 501, and when the lock release button 510a is released, the rotation of the link portion 510 is locked in place.

On the back side of the grip body 501, a first leg 501a and a second leg 501b, which are symmetrically shaped, are rotatably supported. By opening the first leg 501a and the second leg 501b, the grip accessory 500 can be stably supported at three points (the grip body 501, the first leg 501a, and the second leg 501b) and can be used as a tripod.

An operation portion 520 is used to operate the camera 100 and is positioned to be detachable from the grip body 501. The operation portion 520 includes operation buttons for executing functions frequently used with the camera 100. For example, the operation portion 520 includes a mode switch member 520a for switching between video and still image shooting, and a shutter button 520b to start/stop the shooting operation. Additionally, it includes an AF button 520c for driving the focus unit within the lens unit 3 to adjust focus, and a zoom button 520d to control the lens unit 3 in the wide/telephoto direction. The operation portion 520 outputs various control signals to the camera 100 via wireless communication. When shooting while holding the grip accessory 500, the operation portion 520 is positioned where the user can operate it with their thumb, improving usability. Moreover, since the operation portion 520 can be detached and used separately, the grip accessory 500 can function as a tripod, allowing the user to take photos from a distance away from the camera 100.

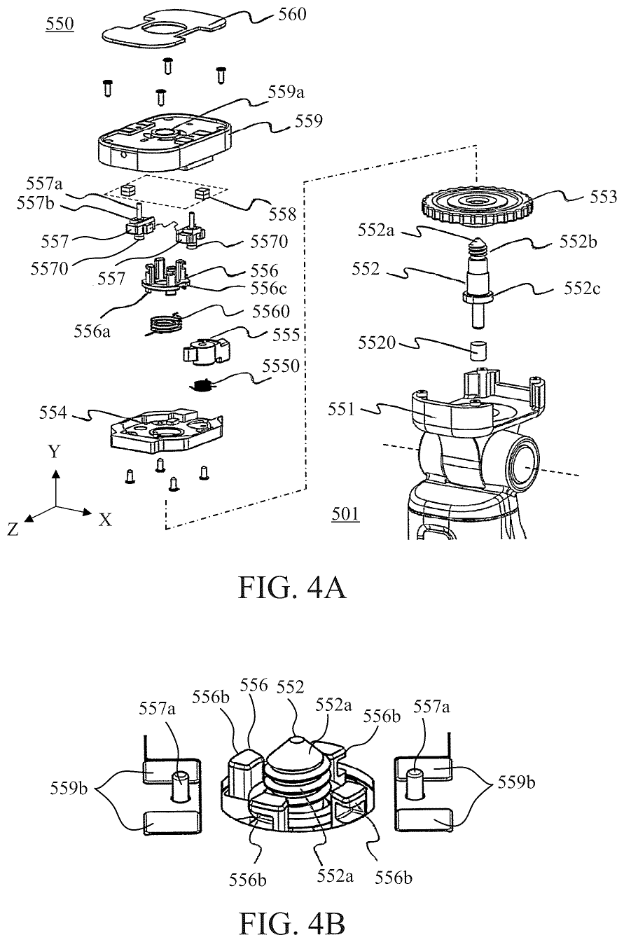

FIG. 4 is a diagram illustrating the platform 550. FIG. 4A is an exploded perspective view of the platform 550, and FIG. 4B is an enlarged view illustrating the structure corresponding to the bayonet tightening portion 24 on the camera 100 side.

The platform 550 includes a hinge cover 551, a centering pin 552, a rotation operating member 553, an intermediate cover 554, a lever (release member) 555, a bayonet member 556, the pushpin 557, a magnet 558, a top cover 559, and a cushion member 560. The exterior of the platform 550 is primarily formed by the hinge cover 551, which are molded from resin material, the intermediate cover 554, and the top cover 559. The hinge cover 551 is held so that it can rotate around the X-axis relative to the grip body 501. The rotation operating member 553 is held by the hinge cover 551 so that it can rotate around the Y-axis, and it is clamped with a gap between the hinge cover 551 and intermediate cover 554, allowing rotation in the Y-axis direction. The centering pin 552 is positioned at a location corresponding to the center of the female screw portion 21a of the camera 100. The tip of the centering pin 552 is equipped with an inclined portion 552a. On the lower side of the inclined portion 552a in the Y-axis direction, a male screw (second screw engagement portion) 552b, which screws into the female screw portion 21a, and a flange portion 552c are provided at the tip protruding from the platform 550. The centering pin 552 is held so that it can rotate integrally with the rotation operating member 553 and is also held to move up and down along the Y-axis direction, being constantly urged upward by a compression spring 5520. The Y-axis position of the centering pin 552 is restricted by the flange portion 552c contacting with the rotation operating member 553.

The bayonet member 556 is positioned on the top cover 559, centered around the centering pin 552. The bayonet member 556 has a through-hole 556a and is held so that it can rotate around the Y-axis relative to the hollow rotation shaft 559a formed around the centering pin 552 on the top cover 559. Around the through-hole 556a, a bayonet claw portion 556b is formed to engage with the mount claw portion 25a of the camera 100. The bayonet member 556 is also held to move up and down along the Y-axis direction and is urged upward by a bayonet spring 5560. The bayonet spring 5560 functions as both a compression spring and a torsion spring, biasing the bayonet member 556 in the rotational direction to engage with the mount claw portion 25a (hereinafter simply referred to as the engagement direction).

A pair of the pushpins 557 are arranged in opposition along the X-axis with the centering pin 552 as the center. Each pushpin 557 has a metal shaft 557a with resin material insert-molded to form the base part 557b, creating an integral component. The base part 557b fits into a pair of rotation-regulating grooves (concave portions) 556c of bayonet member 556, with convex portions 557c formed to restrict the rotation of the bayonet member 556. The pushpin 557 is held against the top cover 559 in the Y-axis direction, capable of moving back and forth, and is urged upward in the Y-axis direction by compression spring 5570. The shaft 557a of the pushpin 557 protrudes from the top cover 559 and fits into the lock groove 25c of the camera 100 when the camera 100 and the grip accessory 500 are attached, thereby regulating the rotation of the camera 100.

The magnet 558 is positioned at the corresponding location to the magnet 26 of the camera 100, providing suction and adhesion forces to the camera 100 and the grip accessory 500. The magnet 558 is mounted directly below a contact surface 559b of the top cover 559 formed with resin material, and fixed in place using adhesive or similar means.

In the Y-axis direction, the centering pin 552 is positioned to protrude further than the bayonet claw portion 556b and the pushpin 557. With this height arrangement, when mounting the camera 100 and the grip accessory 500, the centering pin 552 first contacts with the female screw portion 21a of the camera 100, aligning the centers of the camera 100 and the grip accessory 500. Afterward, the suction force of the magnets (558 and 26) positioned on both sides pulls the camera 100 and the pushpin 557 of the grip accessory 500 into alignment with the lock groove 25c of the camera 100 (hereinafter referred to simply as the mounting phase). The bayonet claw portion 556b is positioned corresponding to the mount concave portion 25b and fits into the bayonet claw holder 21e. In the mounting phase, only the pushpin 557 is pushed along the Y-axis, and the convex portion 557c of the pushpin 557 disengages from the pair of rotation-regulating grooves 556c of the bayonet member 556. As a result, the bayonet member 556 rotates in the engagement direction due to the bayonet spring 5560, achieving an engaged state with the mount claw portion 25a. When removing the camera 100 from the grip accessory 500, the lever 555 is operated. This rotates the bayonet member 556 in the opposite direction to the engagement direction (hereinafter simply referred to as the disengagement direction), moving it from the locked position, where it engages with the mount claw portion 25a, to the unlocked position, where it no longer engages with the mount claw portion 25a. This disengages the bayonet claw portion 556b from the mount claw portion 25a, allowing camera 100 to be removed.

In this embodiment, the configuration where the bayonet member 556 automatically rotates when the pushpin 557 is pressed, bringing the bayonet claw portion 556b and the mount claw portion 25a into an engaged state has been explained. However, it is also possible to have a configuration where the lever 555 is operated manually to achieve the engaged state.

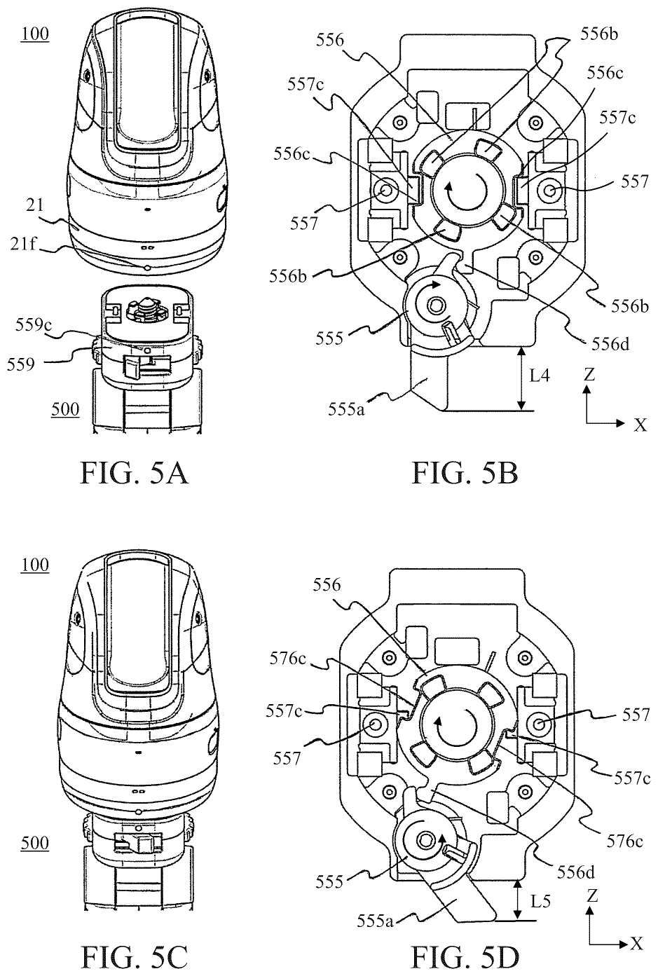

FIGS. 5A, 5B, 5C, and 5D are diagrams illustrating the operation of the internal components of the platform 550 when the camera 100 and the grip accessory 500 are mounted. FIG. 5A illustrates the state before the camera 100 and the grip accessory 500 are mounted, and FIG. 5B illustrates the state of the internal components of the platform 550 before the mounting of the camera 100 and the grip accessory 500. Indicators 21f and 559c, which serve as markers for the mounting phase, are engraved on the bottom cover 21 of the camera 100 and the top cover 559 of the grip accessory 500, respectively. The indicator 559c of the top cover 559 is also engraved on the opposite side, allowing the camera 100 to be mounted even after being rotated 180 degrees around the Y-axis from the state shown in FIG. 5C. Before the camera 100 is mounted, the bayonet member 556 is urged clockwise by the bayonet spring 5560, but its rotation is restricted as the convex portion 557c of the pushpin 557 fits into the rotation-regulating groove 556c. The lever 555 is rotatably held on the axis of the top cover 559 (not illustrated) and is urged clockwise by torsion spring 5550. The lever 555 stops when it contacts the extension portion 556d, which extends radially from bayonet member 556.

FIG. 5C illustrates the state when the camera 100 and the grip accessory 500 are mounted, and FIG. 5D illustrates the state of the internal components of the platform 550 after mounting. When the camera 100 and the grip accessory 500 are mounted, the pushpin 557 is pushed downward in the Y-axis direction, disengaging the fit between the convex portion 557c of the pushpin 557 and the rotation-regulating groove 556c. As a result, the bayonet member 556 is urged to rotate clockwise by the bayonet spring 5560, and it continues to rotate until it contacts the stopper surface (not illustrated) of the top cover 559, bringing the bayonet claw portion 556b and the mount claw portion 25a into an engaged state. In other words, the user only needs to place the camera 100 onto the grip accessory 500 for the bayonet member 556 and the mount claw portion 25a to automatically achieve a mechanical engagement, eliminating the need for cumbersome actions like turning screws, as required by conventional tripod accessories. In the engaged state, lever 555 rotates counterclockwise, pushed by the extension portion 556d of the bayonet member 556. By rotating the lever 555 clockwise, the bayonet member 556 is rotated counterclockwise against the force of the bayonet spring 5560, thereby releasing the mechanical engagement. Afterward, the user can remove the camera 100 by overcoming the magnetic force of the magnets 558 and 26. A finger hook portion 555a of the lever 555 is designed such that the protrusion amount L5 in the engaged state, as illustrated in FIG. 5D, is smaller than the protrusion amount L4 in the disengaged state, as illustrated in FIG. 5B. This transition in the position of the lever 555 prevents the user from accidentally touching the finger hook portion 555a and unintentionally disengaging the connection while in the engaged state.

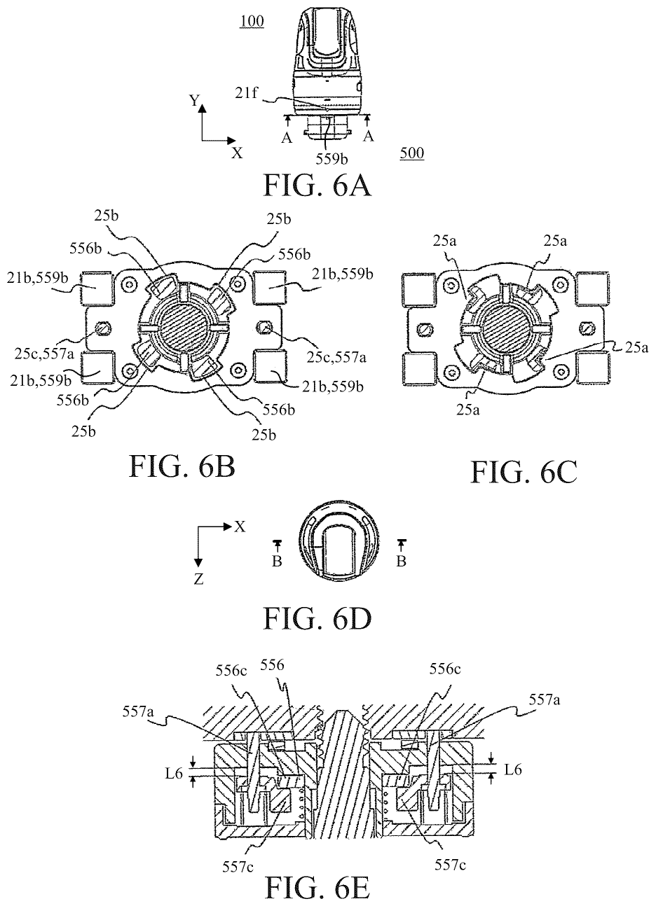

FIGS. 6A, 6B, 6C, 6D, and 6E illustrate the operation of the bayonet member 556 when the camera 100 and the grip accessory 500 are mounted during the mounting phase. FIGS. 6A and 6D illustrate sectional views of the positions, FIG. 6B is a cross-sectional view along the line A-A just before mounting, FIG. 6C is a cross-sectional view along line A-A immediately after mounting, and FIG. 6E is a cross-sectional view along the line B-B. When mounted using the indicators 21f and 559c engraved on the camera 100 and the grip accessory 500, respectively, the suction force of the magnets 26 and 558 on both sides draws the contact surfaces 21b and 559c together until they touch. The shaft 557a of the pushpin 557 fits into the lock groove 25c of the mount member 25, moving downward by a predetermined distance L6 in the Y-axis direction. At this time, the bayonet claw portion 556b is positioned corresponding to the mount concave portion 25b and enters the bayonet claw holder 21e. In other words, during the mounting phase, only the pushpin 557 moves by the distance L6, while the bayonet member 556 does not move in the Y-axis direction. The distance L6 is set to be greater than the engagement amount between the rotation-regulating groove 556c of the bayonet member and the convex portion 557c of the pushpin 557. That is, the convex portion 557c of the pushpin 557 moves below bayonet member 556 in the Y-axis direction, releasing the rotation restriction on bayonet member 556 and allowing it to rotate. This enables the bayonet claw portion 556b to rotate in the engagement direction due to the force of the bayonet spring 5560, resulting in an engaged state with the mount claw portion 25a.

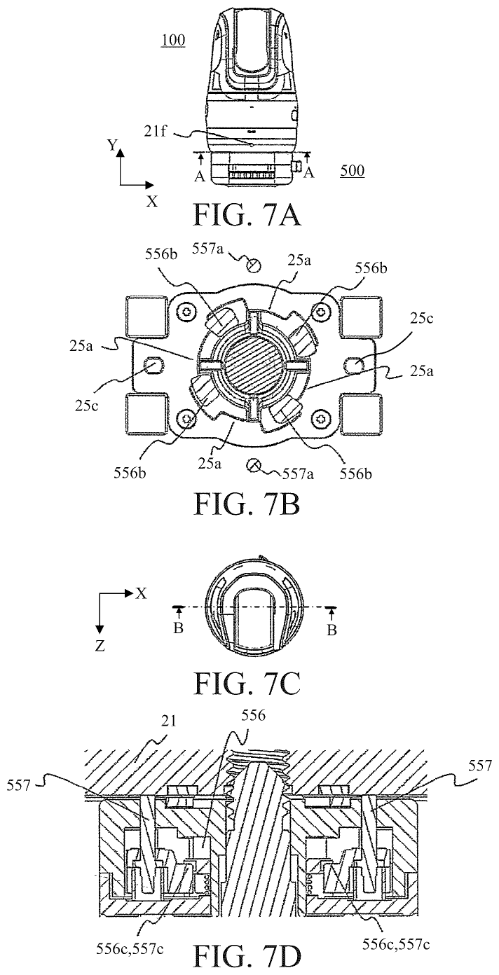

FIGS. 7A, 7B, 7C, and 7D illustrate the operation of the bayonet member 556 during the non-mounting phase when the camera 100 and the grip accessory 500 are mounted. FIGS. 7A and 7C illustrate sectional views of the positions, FIG. 7B is a cross-sectional view along the line A-A, and FIG. 7D is a cross-sectional view along the line B-B. In the non-mounting phase, the bayonet claw portion 556b contacts the mount claw portion 25a and is pushed downward in the Y-axis direction. The pushpin 557 is also pushed downward in the Y-axis direction as it contacts the bottom cover 21 of the camera 100. In this way, during the non-mounting phase, both the bayonet member 556 and the pushpin 557 are pushed downward in the Y-axis direction, and the rotation-regulating groove 556c of the bayonet member remains engaged with the convex portion 557c of the pushpin 557, preventing the bayonet member 556 from rotating. This explanation has described the state where the position is rotated 90 degrees from the mounting phase, but in other non-mounting phases, the bayonet member 556 and the pushpin 557 remain in the same state, and the connection does not occur outside the mounting phase. However, if the camera 100 or the grip accessory 500 is rotated from the non-mounting phase to align with the mounting phase, the bayonet claw portion 556b and the mount claw portion 25a will engage in the connected state as explained in FIGS. 5A, 5B, 5C, and 5D.

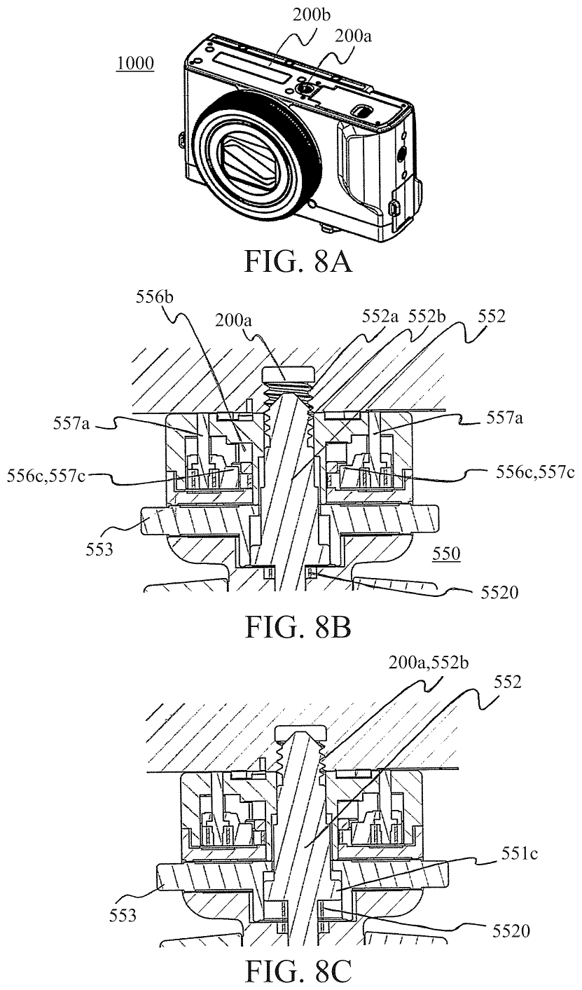

FIGS. 8A, 8B, and 8C are diagrams illustrating how to attach a conventional camera 200, which is equipped with only a female screw portion 200a and does not have the bayonet tightening portion 24, to the grip accessory 500. FIG. 8A is a bottom perspective view of the camera 200, FIG. 8B is a cross-sectional view of the mounted state, and FIG. 8C is a cross-sectional view of the centering pin 552 screwed into the female screw portion 200a. Since the camera 200 does not have a shape corresponding to the bayonet claw portion 556b or the shaft 557a of the pushpin 557, the bayonet member 556 and the pushpin 557 are pushed downward in the Y-axis direction, just as in the non-mounting phase explained in FIGS. 7A, 7B, 7C, and 7D. In other words, the rotation-regulating groove 556c of the bayonet member 556 and the convex portion 557c of the pushpin 557 remain engaged, and the bayonet member 556 does not rotate. The centering pin 552 is pushed downward by the contact between the inclined portion 552a of the centering pin 552 and the female screw portion 200a, and it retracts into the platform 550 while compressing the compression spring 5520. As explained in FIG. 4, a male screw 552b is formed on the centering pin 552 to correspond to the female screw portion 200a. From the state illustrated in FIG. 8B, the rotation operating member 553 is rotated in the screw-tightening direction. As a result, the centering pin 552 rotates integrally with the rotation operating member 553, and the male screw 552b screws into the female screw portion 200a while rotating under the force of the compression spring 5520. When the flange portion 552c of the centering pin 552 comes into contact with the rotation operating member 553, further rotation of the rotation operating member 553 in the screw-tightening direction becomes impossible. Thus, the camera 200 and the grip accessory 500 are fixed together. Furthermore, when the rotation operating member 553 is rotated in the opposite direction from the screw-tightening direction, the centering pin 552, which rotates integrally with the rotation operating member 553, retracts into the grip accessory 500 while compressing the compression spring 5520. Once the male screw portion 552b is fully disengaged from the female screw portion 200a, the camera 200 can be removed from the grip accessory 500. In this way, by configuring the centering pin 552, the grip accessory 500 becomes attachable and detachable even to conventional cameras 200.

### Second Embodiment

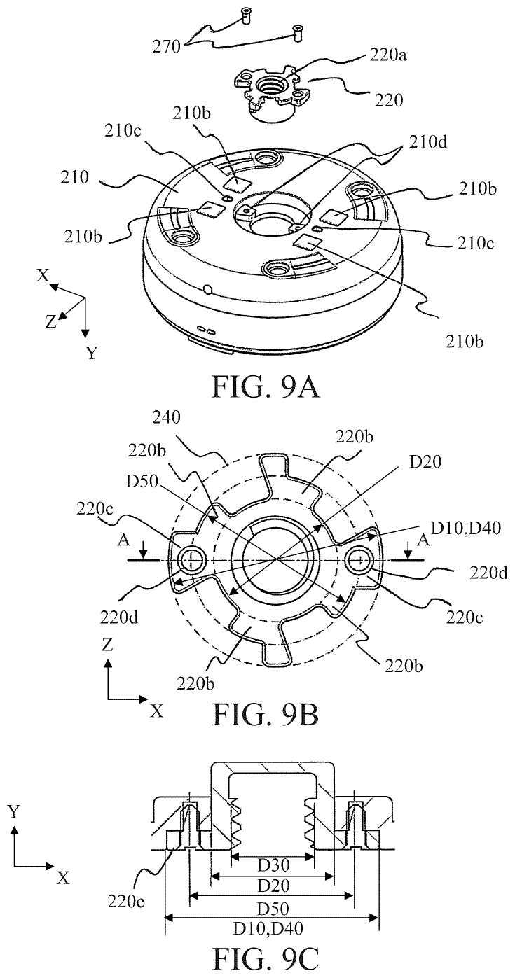

FIGS. 9A, 9B, and 9C are diagrams illustrating the bayonet tightening portion 240. FIG. 9A is an exploded perspective view of the bottom cover 210, FIG. 9B is a bottom view of a female screw member 220, and FIG. 9C is a cross-sectional view along the line A-A.

The female screw member 220 is manufactured by machining or casting metal, and the female screw portion (first screw engagement portion) 220a is integrally formed for fastening with the male screw portion of a general-purpose camera accessory. Around the female screw portion 220a, a bayonet tightening portion 240, corresponding to the bayonet member 556 of the grip accessory 500, is formed.

The bayonet tightening portion 240 includes a bottom cover 210 and a female screw member (screw engagement member) 220 screwed into the bottom cover 210. The female screw member 220 is formed with a plurality of mounting claws (first lock portion) 220b around the female screw portion 220a and a screw engagement portion 220c. The screw engagement portion 220c is arranged opposite to the female screw portion 220a along the X-axis and extends outward in the radial direction beyond the mounting claws 220b. The bottom cover 210 is formed with a pair of lock grooves 210c into which the pushpins 557 of the grip accessory 500 fit. The bottom cover 210 is provided with four contact surfaces 210b that contact the grip accessory 500. The contact surfaces 210b are symmetrically arranged on both sides of the Z-axis with the pair of lock grooves 210c at the center. The female screw member 220 is fixed to the bottom cover 210 with two screws 270 located inside the bayonet tightening portion 240. The screws 270 are countersunk screws, and the screw holes 220d of the female screw member 220 have a chamfered shape corresponding to the taper shape of the countersunk screw head. This configuration allows the tapered shape and the chamfered shape to contact each other on an inclined plane in the screw tightened state, reducing positional displacement due to falling or impact and ensuring that the screw head does not protrude from the surface 220e of the female screw member 220.

Next, the size of the bayonet tightening portion 240 in the radial direction (X-axis and Z-axis directions) will be explained. The female screw portion 220a of the female screw member 220 is formed with a standardized unified thread, with a nominal size of ¼ inch, which determines the minor diameter D30 of the thread. The inner diameter D20 of the bayonet tightening portion 240 is larger than the minor diameter D30 of the thread to ensure sufficient wall thickness for the female screw portion 220a to meet the required strength. The outer diameter D50 of the mounting claw 220b extends outward from the inner diameter D20 of the bayonet tightening portion 240, making it larger than the inner diameter D20. The screw hole 220d is positioned outside the inner diameter D20 and located approximately on the circumference of the outer diameter D50 of the mounting claw 220b. The outer diameter D40 of the screw engagement portion 220c is larger than the outer diameter D50. In other words, the outer diameter D40 of the screw engagement portion 220c becomes the maximum outer diameter and defines the outer diameter D10 of the bayonet tightening portion 240.

### Third Embodiment

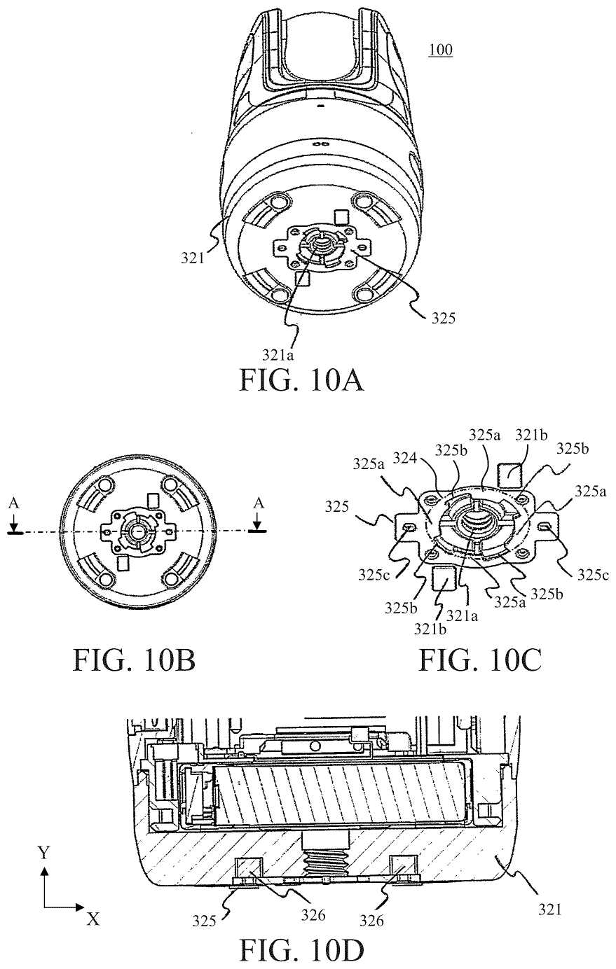

FIGS. 10A, 10B, 10C, and 10D are diagrams illustrating the appearance of the camera 100 in this embodiment. FIG. 10A is a perspective view of the bottom cover 321, FIG. 10B is a bottom view of the camera 100, FIG. 10C is an enlarged view of a bayonet tightening portion 324, and FIG. 10D is a cross-sectional view along the line A-A illustrating the internal structure.

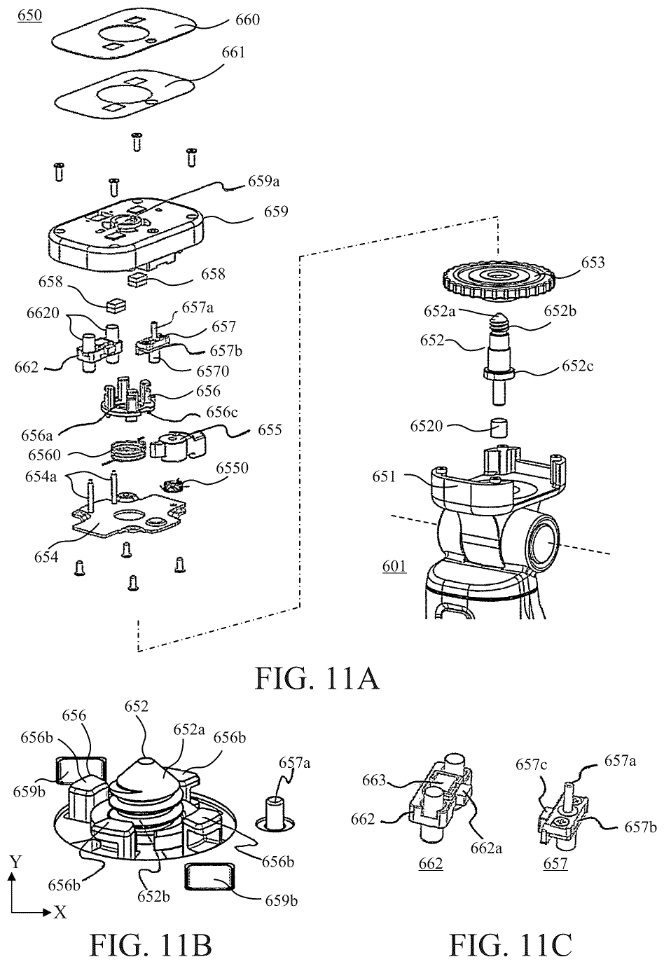

A female screw portion 321a is formed on the bottom surface of the bottom cover 321 to engage with the male screw portion of a generic camera accessory. Surrounding the female screw portion 321a, the bayonet tightening portion 324 is formed to correspond to the bayonet member (rotation locking member) 656 of the grip accessory 500 (see FIGS. 11A, 11B, and 11C). The bayonet tightening portion 324 is composed of the bottom cover 321 and a mount member 325 that is screwed into the bottom cover 321. The mount member 325 is made by pressing a metal plate and serves as the structural component for securing the grip accessory 500, providing high rigidity and strength. The mount member 325 has an opening centered on the female screw portion 321a, with a plurality of mount claw portions (first lock portion) 325a and a mount concave portion 325b formed. Additionally, the mount member 325 is equipped with a pair of lock grooves 325c, where pushpins 657 of the grip accessory 500 (see FIGS. 11A, 11B, and 11C) fit. When the camera 100 and grip accessory 500 are attached (hereafter referred to simply as the “attached state”), the pushpins 657 fit into the lock grooves 325c, restricting the rotation of the grip accessory 500 and the camera 100. The pair of lock grooves 325c are arranged along the X-axis, opposite each other, with the female screw portion 321a at the center, positioned outward from the mount concave portion 325b. The bottom cover 321 also has two contact surfaces 321b, which contacts with the grip accessory 500. These contact surfaces 321b are positioned opposite each other, centered around the female screw portion 321a. Inside the two contact surfaces 321b, a magnet 26 (for securing) is placed to hold the camera 100 to the grip accessory 500 when attached. Additionally, as shown in FIG. 10C, two other magnets 326 are positioned on the inner side of the camera 100, aligned with the lock grooves 325c of the bottom cover 321. These magnets 326 function, as explained later, to engage the bayonet member 556 and the mount member 325 when the camera 100 is mounted on the platform 550.

FIGS. 11A, 11B, and 11C are diagrams illustrating a platform 650. FIG. 11A is an exploded perspective view of the platform 650, FIG. 11B is an enlarged view illustrating the structure corresponding to the bayonet tightening portion 324 on the camera 100 side, and FIG. 11C is an enlarged view illustrating the structure of a magnet holder 662 and the pushpin 657, which will be described later.

The platform 650 includes a hinge cover 651, a centering pin 652, a rotation operating member 653, an intermediate plate 654, a lever 655, bayonet member 656, and the pushpin 657. Additionally, the platform 650 includes the magnet holder 662, the fixing magnet 658, the top cover 659, and the cushion member 660.

The exterior of the platform 650 is primarily composed of the hinge cover 651 and the top cover 659, which are molded from resin material. The hinge cover 651 is held in a manner that allows it to rotate around the X-axis relative to the grip body 601. The rotation operating member 653 is held in a manner that allows it to rotate around the Y-axis within the hinge cover 651, and in the Y-axis direction (thrust direction), it is clamped with a rotatable clearance between the hinge cover 651 and the intermediate plate 654. The centering pin 652 is provided at a position corresponding to the center of the female screw portion 321a of the camera 100. An inclined portion 652a is formed at the tip of the centering pin 652, and on the lower side of the inclined portion 652a in the Y-axis direction, a male screw 652b corresponding to the female screw portion 321a and a flange portion 652c are formed. The centering pin 652 is held so that it can rotate integrally with the rotation operating member 653 and can also move forward and backward in the Y-axis direction (thrust direction), being urged upward in the Y-axis direction by a compression spring 6520. The position of the centering pin 652 in the Y-axis direction is restricted by the flange portion 652c coming into contact with the rotation operating member 653. The bayonet member 656 is arranged on the top cover 659 with the centering pin 652 as the center. The bayonet member 656 is formed with a through hole 656a and is held rotatably around the Y-axis in relation to the hollow rotating shaft 659a formed at the center of the centering pin 652 in the top cover 659. Around the through hole 656a, a bayonet claw 656b that engages with the mount claw portion 325a of the camera 100 is formed. Furthermore, the bayonet member 656 is held in a manner that allows it to move forward and backward in the Y-axis direction (thrust direction), being urged upward in the Y-axis direction by a bayonet spring 6560. The bayonet spring 6560 functions not only as a compression spring but also as a torsion spring, urging the bayonet member 656 in the rotational direction to engage with the mount claw portion 325a (hereinafter referred to simply as the engagement direction).

The pushpin 657 is positioned around the centering pin 652, with the magnet holder 662 located on the opposite side, centered on the centering pin 652. The pushpin 657 is an integrated component formed by insert-molding resin material onto a metal shaft 657a, creating a base portion 657b. A convex portion 657c, which fits into a rotation restriction groove 656c of the bayonet member 656 and restricts the rotation of the bayonet member 656, is formed on the base portion 657b. The pushpin 657 is held in a manner that allows it to move forward and backward along the Y-axis relative to the top cover 659, and is urged upward along the Y-axis by a compression spring 6570. The metal shaft 657a of the pushpin 657 protrudes from the top cover 659 and, when the camera 100 and grip accessory 500 are attached, fits into the lock groove 325c of the camera 100 to restrict the camera's rotation. Similarly, the magnet holder 662 is guided by two shafts 654a, which are crimped into the intermediate plate 654, allowing it to slide and move forward and backward along the Y-axis relative to the top cover 659. It is urged downward along the Y-axis by a compression spring 6620. As illustrated in FIG. 11C, a magnet 663 is fixed to the magnet holder 662 by adhesive or a similar material, and when the magnet 326 of the camera 100 approaches, it attracts, causing the magnet holder 662 to move toward the camera 100. A convex portion 662a, which fits into the rotation restriction groove 656c of the bayonet member 656 to restrict the rotation of the bayonet member 656, is formed on the magnet holder 662.

The fixing magnet 658 is positioned to correspond with the magnet 326 of the camera 100, providing attraction and holding force when the camera 100 and the grip accessory 500 are attached. The fixing magnet 658 is assembled just below the contact surface 659b from the inside of the top cover 659, which is made of resin material, and is fixed with adhesive or similar materials. In the Y-axis direction, the centering pin 652 is positioned to protrude more than the bayonet claw 656b and the pushpin 657. With this height relationship, when attaching the camera 100 to the grip accessory 500, the centering pin 652 first comes into contact with a female screw portion 321a of the camera 100, centering the camera 100 and the grip accessory 500. After that, if the positions of the lock groove 325c of the camera 100 and the pushpin 657 of the grip accessory 500 match (hereinafter referred to simply as the ‘mounting phase’), the bayonet claw 656b aligns with the mount concave portion 325b and enters the bayonet claw holder 321e. In the mounting phase, only the pushpin 657 is pushed along the Y-axis, and the convex portion 657c of the pushpin 657 disengages from the rotation restriction groove 656c of the bayonet member 656. Furthermore, the magnet 663 of the magnet holder 662 is attracted to the magnet 326 of the camera 100, causing the magnet holder 662 to move toward the camera 100 along the Y-axis, and the convex portion 662a of the magnet holder 662 disengages from the rotation restriction groove 656c of the bayonet member 656. As a result, the bayonet member 656 rotates in the engagement direction due to the bayonet spring 6560, entering an engaged state with the mount claw portion 325a. When removing the camera 100 from the grip accessory 500, the bayonet claw 656b disengages from the mount claw portion 325a by rotating the bayonet member 656 in the direction opposite to the engagement direction through the operation of the lever 655, allowing the camera 100 to be removed.

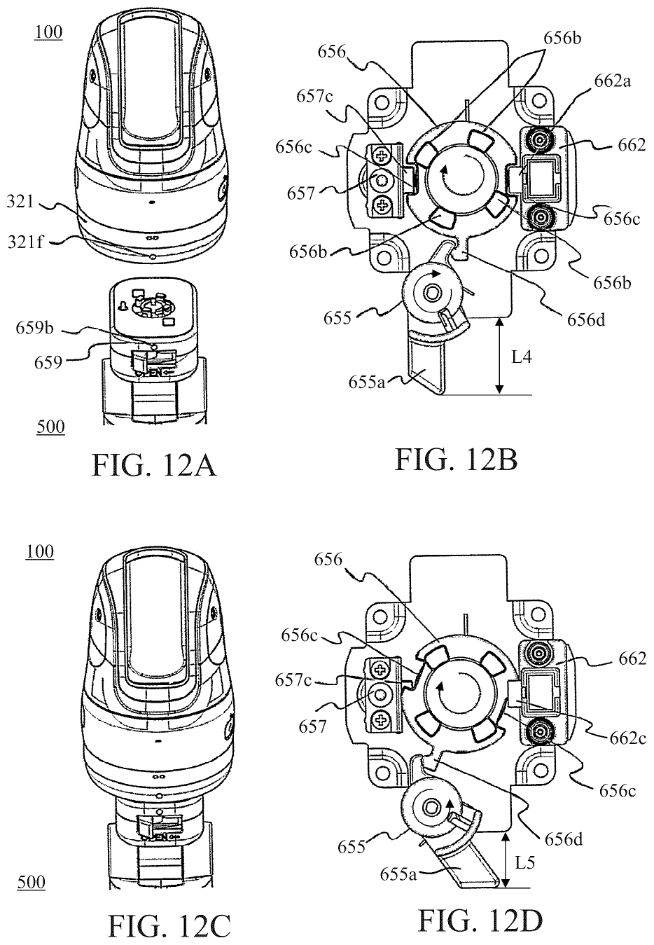

FIGS. 12A, 12B, 12C, and 12D are diagrams illustrating the operation of the internal components of the platform 650 when the camera 100 and the grip accessory 500 are attached. FIG. 12A illustrates the state before the camera 100 and the grip accessory 500 are attached, and FIG. 12B illustrates the internal components of the platform 650 before attachment. Alignment markers 321f and 659b, which serve as indicators for the mounting phase alignment, are engraved on the bottom cover 321 of the camera 100 and the top cover 659 of the grip accessory 500, respectively. Before the camera 100 is attached, the bayonet member 656 is urged clockwise by the bayonet spring 6560 but is restricted from rotating due to the engagement of the convex portion 657c of the pushpin 657 and the rotation restriction groove 656c. At the same time, the rotation restriction groove 656c on the opposite side of the bayonet member 656 engages with the convex portion 662a of the magnet holder 662, further restricting rotation. The lever 655 is held rotatably relative to the shaft portion (not shown) of the top cover 659 and is urged clockwise by a torsion spring 6550. The lever 655 is stopped by coming into contact with an extension portion 656d, which extends radially from the bayonet member 656.

FIG. 12C illustrates the camera 100 with the grip accessory 500 attached, and FIG. 12D illustrates the internal components of platform 550 after attachment. When the camera 100 and the grip accessory 500 are mounted, the pushpin 657 is pushed in the Y-axis direction, causing the disengagement of the convex portion 657c of the pushpin 657 with the rotation restriction groove 656c. Simultaneously, on the opposite side, the magnet holder 662 moves towards the camera 100 side, disengaging the convex portion 662a of the magnet holder 662 from the rotation restriction groove 656c. As a result, the bayonet member 656 is rotated clockwise by the bayonet spring 6560 until it contacts a stopper surface (not illustrated) on the top cover 659, engaging the bayonet claw 656b with the mount claw portion 325a, thereby achieving a coupled state. In other words, simply placing the camera 100 on the grip accessory 500 automatically achieves a mechanical coupling state via the bayonet member 656, eliminating the need for cumbersome actions such as screwing as required by conventional tripod accessories. In the coupled state, the lever 655 is pushed against the extension portion 656d of the bayonet member 656, causing it to rotate counterclockwise. Rotating the lever 655 clockwise causes bayonet member 656 to rotate counterclockwise against the urging force of the bayonet spring 6560, transitioning to the uncoupled state illustrated in FIG. 12B, enabling easy removal of the camera 100. A finger rest part 655a of the lever 655 is configured so that the protrusion amount L5 in the coupled state illustrated in FIG. 12D is smaller than the protrusion amount L4 in the uncoupled state illustrated in FIG. 12B. This transition in the lever 655 position reduces unintentional contact with the finger rest part 655a when the camera 100 and the grip accessory 500 are coupled, minimizing inadvertent uncoupling. Furthermore, in this configuration, even if the user accidentally presses the pushpin 657 of the platform 650, the magnet holder 662 does not move towards the camera 100 side, thereby preventing unintentional coupling of the bayonet member 656.

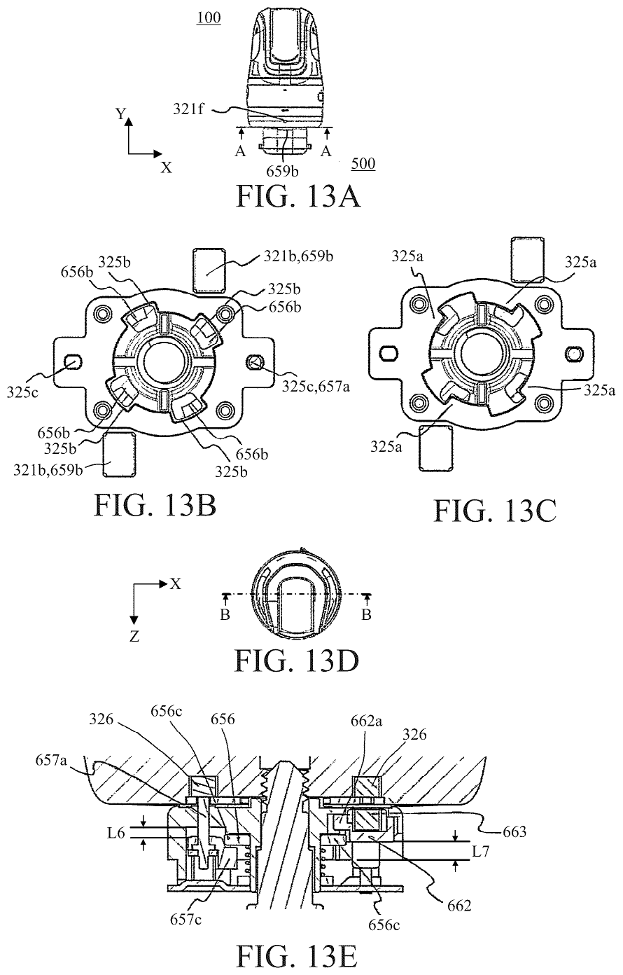

FIGS. 13A, 13B, 13C, 13D, and 13E are diagrams illustrating the operation of the bayonet member 656 during the mounting phase of the camera 100 and the grip accessory 500. FIGS. 13A and 13D illustrate sectional views, FIG. 13B illustrates a sectional view along the line A-A before mounting, FIG. 13C illustrates a sectional view along the line A-A immediately after mounting, and FIG. 13E illustrates a sectional view along the line B-B.

When attempting to attach the camera 100 to the grip accessory 500 using the indicators 321f and 659b engraved on them as guides, the magnetic attraction of the magnets 26 and 658 inside pulls the contact surfaces 321b and 659b together until they meet. The metal shaft 657a of the pushpin 657, while fitting into the lock groove 325c of the mount member 325, moves the predetermined distance L6 in the Y-axis direction. At this point, the bayonet claw 656b is positioned corresponding to the mount concave portion 325b and enters the bayonet claw holder 321e. In other words, in the attached state, the bayonet member 656 does not move in the Y-axis direction, and only the pushpin 657 moves the distance L6. The distance L6 is set to be greater than the engagement amount of the rotation restriction groove 656c of the bayonet member 656 and the convex portion 657c of the pushpin 657. In other words, the convex portion 657c of the pushpin 657 moves below the bayonet member 656 in the Y-axis direction, releasing the rotation restriction of bayonet member 656, allowing the bayonet member 656 to rotate. Additionally, the magnet holder 662 is attracted to the magnet 326 of the camera 100 by the magnet 663 and moves towards the camera 100 side. At this time, a distance L7 of the magnet holder 662 is set greater than the engagement amount of the rotation restriction groove 656c of the bayonet member 656 and the convex portion 662a of the magnet holder 662. In other words, the convex portion 662a of the magnet holder 662 moves the bayonet member 656 in the Y-axis direction, releasing the rotation restriction of the bayonet member 656, making the bayonet member 656 capable of rotating. Consequently, the bayonet claw 656b rotates in the engagement direction due to the bayonet spring 6560, achieving a coupled state by engaging with the mount claw portion 325a. In this state, the magnetic attraction between the magnet 663 of the magnet holder 662 and the magnet 326 of the camera 100 ensures that the camera 100 is securely fixed to the grip accessory 500 without any wobbling.

### Forth Embodiment

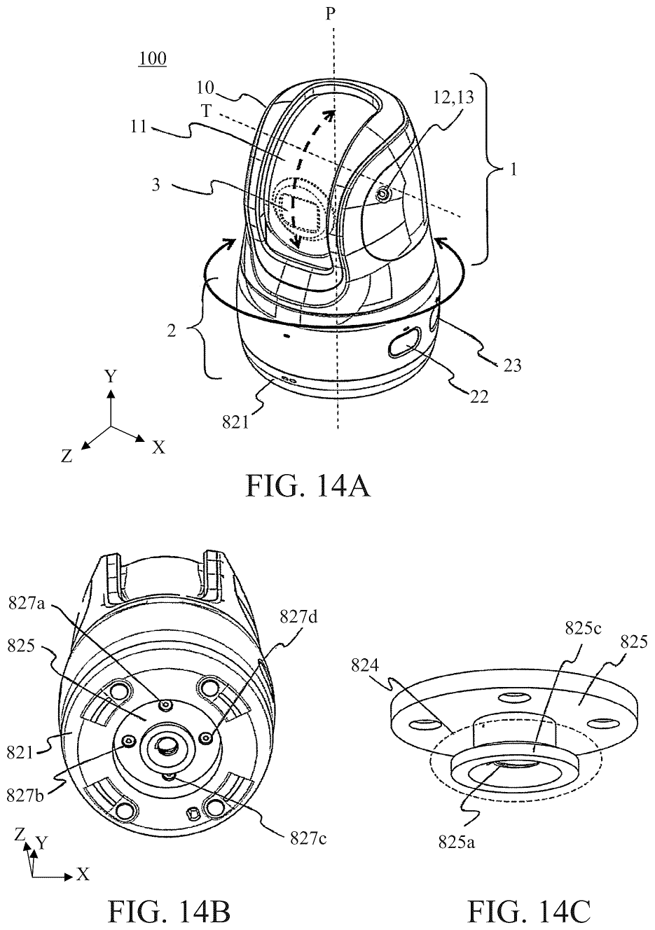

FIGS. 14A, 14B, and 14C are diagrams illustrating the appearance of the camera 100 in the present embodiment.

FIG. 14A is a front perspective view of the camera 100, FIG. 14B is a bottom perspective view of the camera 100, and FIG. 14C is an enlarged view of a lock claw tightening portion 824.

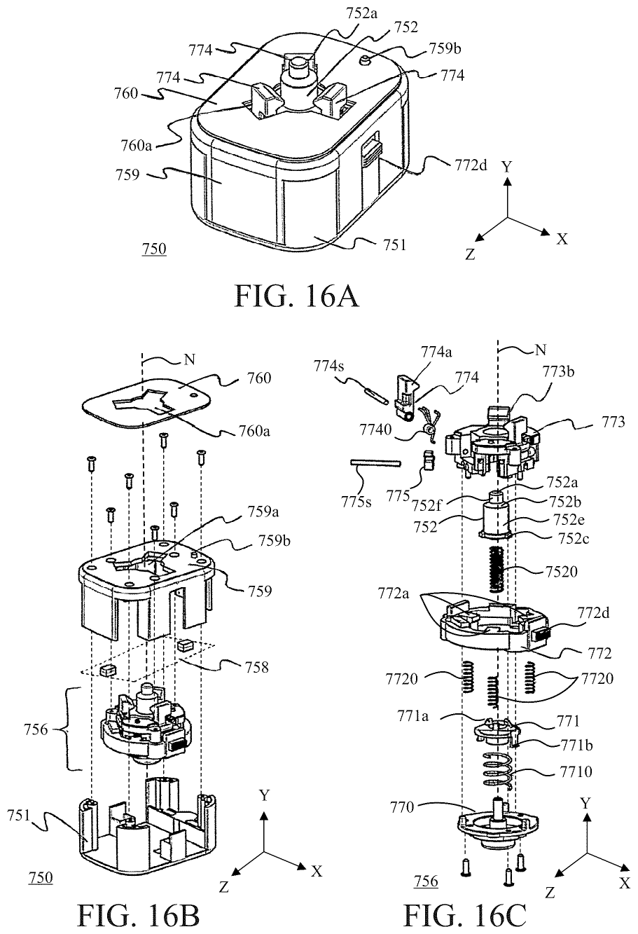

The camera 100 includes a first housing 1 (the top cover 10 and the dome member 11) and a second housing 2 (the bottom cover 821). The mount member 825, which has the lock claw tightening portion 824, is fastened at four points on the bottom surface of the bottom cover 821 with screws 827a, 827b, 827c, and 827d. The mount member 825 is made of metal and serves as the structural component for fastening with the platform 750, which will be described later, thus it is a high-rigidity and high-strength part. A female screw portion (first screw engagement portion) 825a for fastening with the male screw part of a general-purpose camera accessory is formed on the mount member 825. Surrounding the female screw portion 825a is the lock claw tightening portion 824, which corresponds to a lock member 774 of the platform 750 (see FIGS. 16A, 16B, and 16C), described later.

The Y-axis represents the height direction of the camera 100, the direction connecting the screw 827a and the opposing screw 827c (horizontal direction on the paper in FIG. 14B) is defined as the X-axis, and the direction connecting the screw 827b and the opposing screw 827d (vertical direction on the paper in FIG. 14B) is defined as the Z-axis. The XYZ axes will be explained similarly in other figures as well.

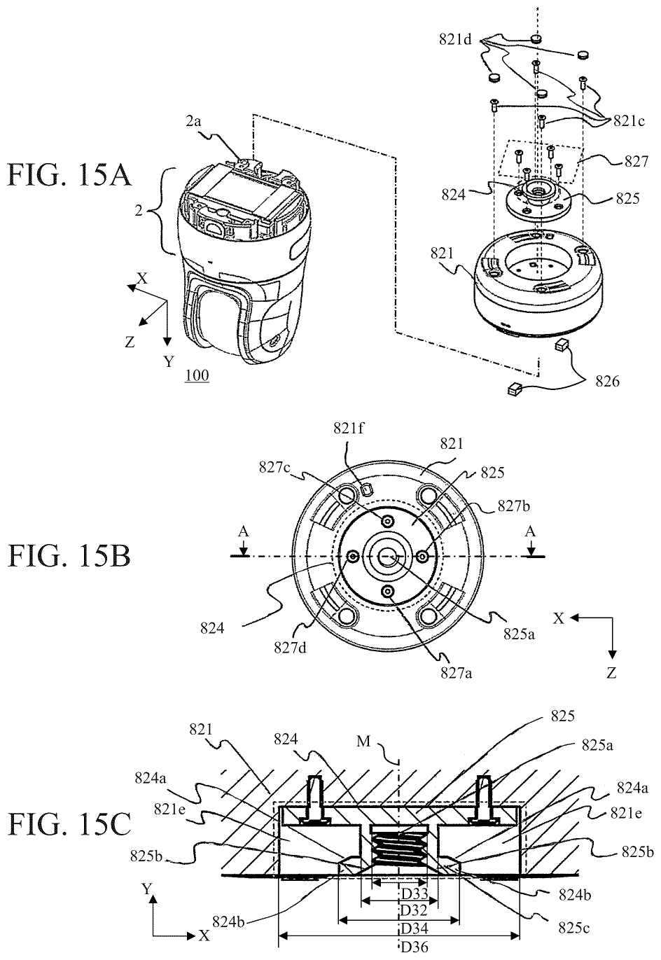

FIGS. 15A, 15B, and 15C are diagrams illustrating the lock claw tightening portion 824 on the bottom surface of the camera 100. FIG. 15A is an exploded perspective view of the second housing 2 of the camera 100. The magnet 826 provides magnetic attraction and adhesion between the camera 100 and the platform 750, which will be described later. The magnet 826 is fixed from the inside of the bottom cover 821, which is made of a resin material, using adhesive or similar means. The mount member 825 is secured to the bottom cover 821 with the four screws 827 (827a, 827b, 827c, and 827d) located outside the lock claw tightening portion 824. The bottom cover 821 is fixed to the main base 2a, which forms the foundation of the second housing 2 and is molded from resin material, using the four screws 821c. Cushion members 821d, which serve as cushioning feet for supporting the camera 100, are affixed directly the four screws 821c.

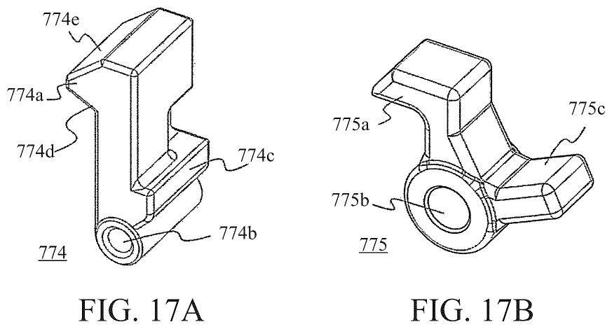

FIG. 15B is a bottom view of the camera 100, and FIG. 15C is a sectional view along the line A-A. On the bottom cover 821, a lock groove 821f is provided to restrict the rotation of the camera 100 and the platform 750, which will be described later. A female screw portion 825a formed in the camera 100 has a standardized unified thread designation of ¼, determining the root diameter D33 of the thread. The inner diameter D32 of the lock claw tightening portion 824 is made larger than the root diameter D33 of the thread to ensure sufficient wall thickness for the female screw portion 825a to meet the required strength. Additionally, around the female screw portion 825a, an inclined portion 825b is formed that widens in diameter from the terminal end of the female screw portion 825a. The terminal end of the female screw portion 825a is formed at a position where a certain height is secured from the bottom surface of the main body. When the inclined portion 825b contacts an inclined portion 752a of a centering pin 752, which will be described later, the camera 100 and the platform 750 are centered. The central axis M of the female screw portion 825a coincides with the rotation axis P of the camera 100. A flange portion (engagement portion) 825c is formed around the female screw portion 825a of the mount member 825. The flange portion 825c protrudes in the normal direction of the female screw portion 825a and is formed concentrically with it. The flange portion 825c is shaped by rotating a cross-sectional shape, consisting of the bottom surface and the inclined portion 825b of the mount member 825, and a right-angle edge 824b connecting the outer diameter D34 and the bottom surface, along with the outer diameter D34 and an inclined portion 824a, around the central axis M. When the camera 100 is mounted on the platform 750, the edge 824b contacts the slope formed on an upper part of a lock claw portion 774a (see FIGS. 16A, 16B, and 16C), causing the lock member 774 to rotate. The outer diameter D34 of the lock claw tightening portion 824 is made larger by the wall thickness to ensure sufficient strength, relative to the outermost diameter of the inclined portion 825b. The inclined portion 824a is formed at the same angle as an inclined surface 774d formed on the lower part of the lock claw portion 774a (see FIG. 17A). Therefore, when the platform 750 and the camera 100 are fixed, the inclined portion 824a and the inclined surface 774d of the lock claw portion 774a contact along their entire surfaces. A lock claw holder 821e, which secures the movable path space for the lock member 774 described later, is formed on the bottom surface of the second housing 2, consisting of the bottom cover 821 and the mount member 825. The lock claw tightening portion 824 is arranged so as not to protrude from the bottom surface of the bottom cover 821. The outer diameter D36 is set to ensure a gap from the movable path of the lock member 774, so as not to hinder the rotation of the lock member 774.

FIGS. 16A, 16B, and 16C are diagrams illustrating the platform 750. FIG. 16A is a front perspective view of the platform 750, FIG. 16B is an exploded perspective view of the platform 750, and FIG. 16C is an exploded perspective view of the lock mechanism 756. FIGS. 17A and 17B are diagrams illustrating the lock member 774. FIG. 17A is a front perspective view of the lock member 774, and FIG. 17B is also a front perspective view of the lock member 774. The height direction of the platform 750 is defined as the Y-axis, the short side direction of the platform 750 is defined as the X-axis, and the long side direction of the platform 750 is defined as the Z-axis. The XYZ axes will also be used to explain other figures.

First, referring to FIG. 16A, the appearance of the platform 750 will be described. The platform 750 is mainly composed of a hinge cover 751 and a top cover 759, both molded from a resin material. The hinge cover 751 and the top cover 759 form the sides of the platform 750 by being fixed in a way that their convex and concave portions alternately overlap. On the side surface along the long side of the platform 750, a pair of operation portions 772d are arranged to release the locked state between the camera 100 and the platform 750. The operation portions 772d have a textured surface to facilitate operation and are held to be movable in a direction parallel to the Y-axis. A positioning pin 759b for the camera 100 is formed on the top surface of the top cover 759. A cushion member 760 is affixed to the top surface of the top cover 759. Both the top cover 759 and the cushion member 760 have through-holes 759a and 760a. These through-holes 759a and 760a have the same shape and have an opening at the center through which the centering pin 752, which moves forward and backward along the Y-axis, passes. Around the opening for the centering pin 752, there are three openings designed to avoid interference with the rotational path of the lock member 774.

The inclined portion 752a of the centering pin 752 protrudes beyond the position of the lock member 774 along the Y-axis. When attempting to mount the camera 100 on the platform 750, the inclined portion 752a of the centering pin 752 first contacts the inclined portion 825b formed around the female screw portion 825a of the camera 100, centering the camera 100 and the platform 750. By further aligning the position of the lock groove 821f of the camera 100 with the positioning pin 759b formed on the top cover 759, the camera 100 is rotationally constrained relative to the platform 750 in this phase, which will hereafter be referred to simply as the “mounting phase.”

Next, referring to FIGS. 16B and 16C, the components of the platform 750 will be described. The platform 750 includes a hinge cover 751, a lock mechanism 756, a magnet 758, a top cover 759, and a cushion member 760. The magnet 758 is positioned inside the top cover 759, which is made of a resin material, and is fixed with adhesive or other means at a location facing the magnet 826 on the camera 100 side. The magnet 758 provides an attractive force between the camera 100 and the platform 750.”

In FIG. 16C, to clarify the structure of the lock member 774, only one of the three lock members 774 and one of the three lock members 775 have been disassembled from a lock portion holding member 773. The lock mechanism 756 includes a holder 770, rotation restricting units 771 and 772, the centering pin 752, the lock portion holding member 773, the lock members 774, and the lock members 775. The lock mechanism 756 is fastened to the top cover 759 with three screws, centered around the centering pin 752.

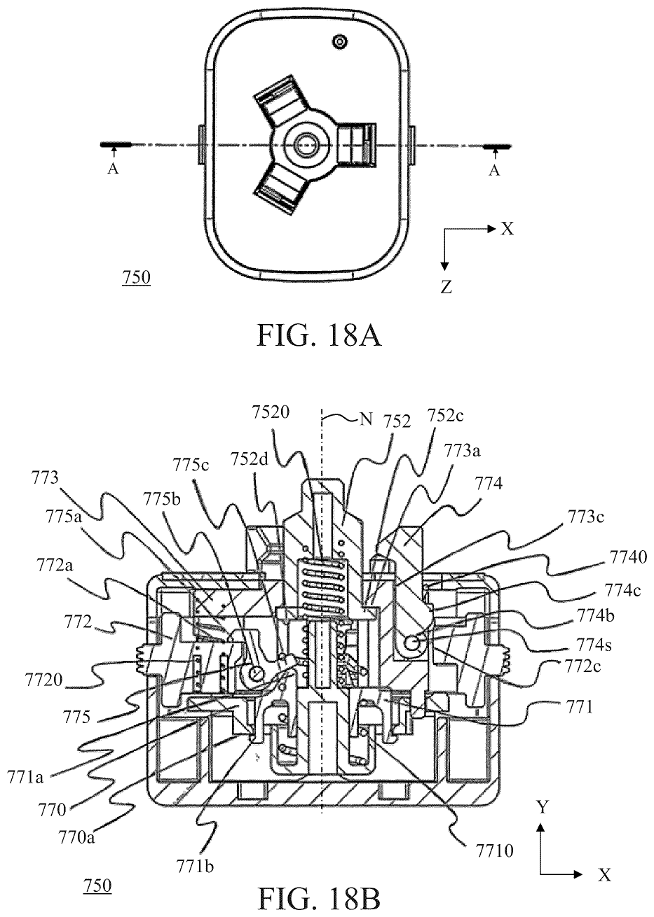

The centering pin 752 is positioned so that the central axis of the female screw portion 825a coincides with the central axis N of the centering pin 752 when the camera 100 and platform 750 are fixed together. The centering pin 752 has two shaft portions, 752f and 752e. The shaft portion 752f has a smaller diameter than the shaft portion 752e and is positioned above the shaft portion 752e in the Y-axis direction. The inclined portion 752a is formed at the tip of the shaft portion 752f, and an inclined portion 752b is formed between the shaft portions 752f and 752e. A flange portion 752c is formed at the lower end of shaft portion 752e, with a larger diameter than the shaft portion 752e. At the bottom of the flange portion 752c, a protrusion 752d is formed (see FIG. 18B). The inclined portion 752b contacts the inclined portion 825b formed around the female screw portion 825a of the camera 100, thereby centering the camera 100 and the platform 750. The centering pin 752 is held in such a way that it can move back and forth in the direction parallel to the Y-axis (the same direction as the central axis of the female screw portion 825a), and is urged upwards in the Y-axis direction by a compression spring 7520.

A through-hole 773b is provided in the lock portion holding member 773. The through-hole 773b is fitted to allow the shaft portion 752e of the centering pin 752 to slide. As a result, the centering pin 752 is restricted to move back and forth along the Y-axis direction, and its central axis is controlled during movement. The three lock members 774 are evenly spaced and arranged in a circular pattern around the through-hole 773b in the lock portion holding member 773. The lock members 774 are formed with a lock claw portion 774a, a hole 774b, and a contact portion 774c. The inclined surface 774d formed at the bottom of the lock claw portion 774a is created at the same angle as the inclined portion 824a of the camera 100. Therefore, when the platform 750 and the camera 100 are fixed together, the inclined portion 824a and the inclined surface 774d engage across their entire surfaces. A hole 774b, into which a shaft 774s can be inserted, is formed in the lock member 774. The central axis N of the shaft 774s is perpendicular to the central axis N of the centering pin 752. The remaining the two shafts 774s, not shown in the figure, are also perpendicular to the central axis N of the centering pin 752. The lock member 774 is rotatably held around the hole 774b, with the shaft 774s fixed to the lock portion holding member 773. The lock member 774 is urged in the direction toward the axis of the centering pin 752 (hereafter simply referred to as the “engagement direction”) by a lock spring 7740. When the platform 750 and the camera 100 are fixed together, the contact portion 774c comes into contact with the contact surface 772c of the rotation restricting unit 772. Additionally, the three lock members 775 are arranged evenly and circularly around the lock portion holding member 773. The lock members 775 are positioned between the lock members 774 circularly arranged, and in a top-down view from the XZ plane, they do not overlap with the lock members 774. The lock members 775 are formed with a lock claw portion 775a, a hole 775b, and a contact portion 775c. The lock claw portion 775a engages with a compression spring upper portion 772a of the rotation restricting unit 772. A hole 775b, into which a shaft 775s can be inserted, is formed in the lock member 775. The lock member 775 is rotatably held around the hole 775b, with the shaft 775s fixed to the lock portion holding member 773.

The rotation restricting unit 772 is held to be movable in the direction parallel to the Y-axis (coaxial with the central axis of the female screw portion 825a) and is urged upward in the Y-axis direction by a compression spring 7720. Three compression springs 7720 are arranged at the same position as the lock member 775 in the XZ-plane projection. The rotation restricting unit 771 is held to be movable in the direction parallel to the Y-axis and is urged upward in the Y-axis direction by a compression spring 7710. A convex portion 771a and a claw portion 771b are formed on the rotation restricting unit 771. Three convex portions 771a are formed at the same position as the lock member 775 in the XZ-plane projection.

FIGS. 18A and 18B are diagrams illustrating the structure of the platform 750. FIG. 18A illustrates the cross-sectional position of the platform 750, and FIG. 18B is a cross-sectional view along the line A-A of the platform 750 in its initial state.

First, referring to FIG. 18B, the detailed structure of the platform 750 will be explained. The centering pin 752 is held to be movable in the direction parallel to the Y-axis and is urged upward in the Y-axis direction by a compression spring 7520. The centering pin 752 is restricted in position in the Y-axis direction by the flange portion 752c coming into contact with the contact portion 773a. The flange portion 752c and the contact portion 773a are arranged in three equally spaced positions in a circular shape.

The lock member 774 is held to be rotatable about the hole 774b and is urged in the engagement direction. The lock spring 7740 is a torsion spring, and the lock member 774 is restricted in position in the engagement direction by coming into contact with the contact surface 773c of the lock portion holding member 773. The lock member 775 is held to be rotatable about the hole 775b. The lower surface of the contact portion 775c comes into contact with the convex portion 771a of the rotation restricting unit 771. The rotation restricting unit 771 is held to be movable in the direction parallel to the Y-axis and is urged upward in the Y-axis direction by a compression spring 7710. Therefore, the lock member 775 is rotated in the direction (counterclockwise on the page of FIG. 18B) toward the rotation restricting unit 772. The rotation restricting unit 771 has its position restricted in the Y-axis direction by the claw portion 771b coming into contact with the contact portion 770a of holder 770. The rotation restricting unit 772 is held to be movable in the direction parallel to the Y-axis and is urged upward in the Y-axis direction by a compression spring 7720. The position of the rotation restricting unit 772 in the Y-axis direction is restricted by the compression spring upper portion 772a coming into contact with the lock claw portion 775a of the lock member 775.

Next, the operation of the platform 750 will be explained. When the centering pin 752 moves downward in the Y-axis direction, the upper surface of the contact portion 775c comes into contact with the protrusion 752d. The rotation restricting unit 771 is urged upward in the Y-axis direction by the compression spring 7710. Therefore, when the downward pressing force of the centering pin 752 in the Y-axis direction becomes greater than the biasing force of the compression spring 7710, the lock member 775 rotates clockwise (in the direction away from the rotation restricting unit 772, as shown in FIG. 18B) around the hole 775b. The position restriction of the rotation restricting unit 772 in the Y-axis direction is released when the lock member 775 rotates, and the engagement between the lock claw portion 774a and the rotation restricting unit 772 is disengaged. As a result, the rotation restricting unit 772 is urged upward and moves in the Y-axis direction by the compression spring 7720. Since the rotation restricting unit 772 moves within the space created by the hinge cover 751 and top cover 759 in the Y-axis direction, it does not interfere with the lock claw holder 821e of the camera 100. At this time, the contact portion 774c of the lock member 774 comes into contact with the contact surface 772c of the rotation restricting unit 772. This prevents the lock member 774 from rotating in the direction opposite to the engagement direction (clockwise in FIG. 18B).

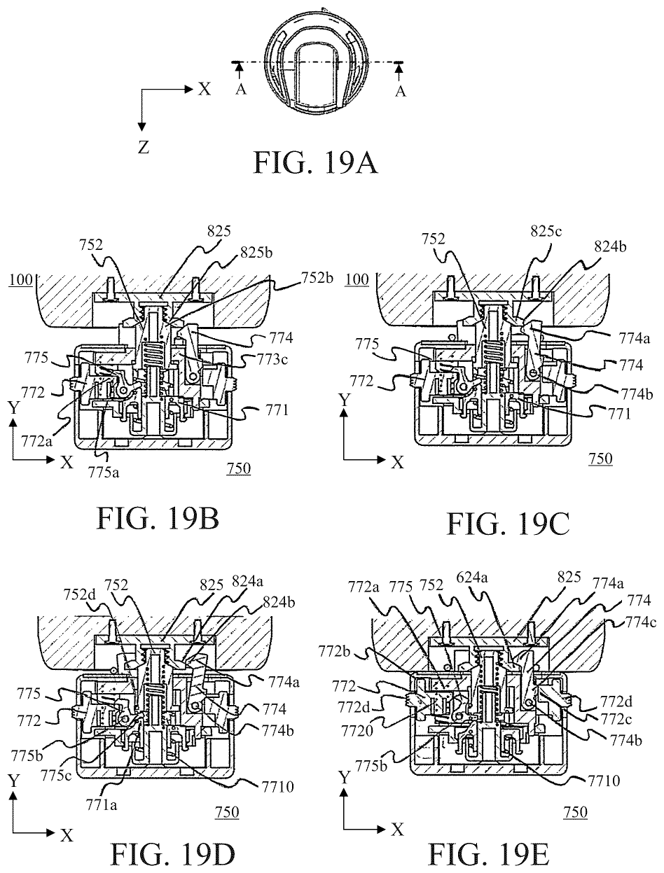

FIGS. 19A, 19B, 19C, 19D, and 19E are diagrams illustrating the operation of the lock mechanism 756 when the camera 100 is mounted on the platform 750. FIG. 19A illustrates the cross-sectional position, FIG. 19B is a cross-sectional view along the line A-A just before the camera 100 is mounted on the platform 750, FIGS. 19C and 19D are cross-sectional views along the line A-A during the mounting process, and FIG. 19E is a cross-sectional view along the line A-A after the camera has been mounted. During the mounting phase, the XYZ axes of the camera 100 and the platform 750, as defined earlier, align and are fixed.

Below, the step-by-step operation of the lock mechanism 756 will be explained using the centering pin 752, the lock member 774, the lock member 775, rotation restricting unit 771, and the rotation restricting unit 772, which form the lock mechanism 756.

First, referring to FIG. 19B, the state just before the camera 100 is mounted on the platform 750 will be explained. When the camera 100 and the platform 750 are brought closer during the mounting phase, the inclined portion 752b of the centering pin 752 comes into contact with the inclined portion 825b of the mount member 825, centering the camera 100 and the platform 750. The lock member 774 is urged in the engagement direction by the lock spring 7740, and its position in the engagement direction is restricted by contact with the contact surface 773c. The lock member 775 is urged in the counterclockwise direction (as seen in FIG. 19B) by the rotation restricting unit 771, which is urged upward in the Y-axis direction, and it is also urged toward the rotation restricting unit 772. The position of the rotation restricting unit 772 in the Y-axis direction is restricted by the contact between the compression spring upper portion 772a and the lock claw portion 775a of the lock member 775.

Next, referring to FIGS. 19C and 19D, the state during the mounting process of the camera 100 on the platform 750 will be explained. FIG. 19C illustrates how the lock member 774 rotates when the camera 100 is pushed downward in the Y-axis direction relative to the platform 750. As the camera 100 is pressed downward in the Y-axis direction toward the platform 750, an inclined surface 774e formed on the upper part of the lock claw portion 774a comes into contact with the edge 824b formed on the flange portion 825c. The lock member 774 then rotates clockwise (in the direction opposite to the engagement direction as illustrated in FIG. 19C) around the hole 774b and retracts. At this time, the state of the lock member 775 and the rotation restricting unit 772 remains the same as in FIG. 19B, just before the camera 100 is mounted on platform 750.

Next, referring to FIGS. 19C and 19D, the state during the process of mounting the camera 100 on the platform 750 will be explained. FIG. 19C illustrates how the lock member 774 rotates when the camera 100 is pushed downward in the Y-axis direction onto the platform 750. When the camera 100 is pressed downward in the Y-axis direction toward the platform 750, the inclined surface 774e formed on the upper part of the lock claw portion 774a comes into contact with the edge 824b formed on the flange portion 825c. Then, the lock member 774 rotates clockwise (in the direction opposite to the engagement direction as illustrated in FIG. 19C) around the hole 774b and retracts. At this time, the state of the lock member 775 and the rotation restricting unit 772 remains the same as in FIG. 19B, just before the camera 100 is mounted on the platform 750.

FIG. 19D illustrates how the lock member 775 rotates when the camera 100 is further pushed downward in the Y-axis direction onto the platform 750. When the camera 100 is pushed further downward in the Y-axis direction from the state illustrated in FIG. 19C, the lock claw portion 774a rides over the edge 824b formed on the flange portion 825c and rotates to a position where it comes into contact with the inclined portion 824a. At this time, the upper surface of the contact portion 775c of the lock member 775 comes into contact with the protrusion 752d of the centering pin 752. When the downward pressing force on the centering pin 752 in the Y-axis direction exceeds the biasing force of the compression spring 7710, the lock member 775 rotates clockwise (in the direction away from the rotation restricting unit 772 as illustrated in FIG. 19D) around the hole 775b.

Next, referring to FIG. 19E, the state where the camera 100 is mounted on the platform 750 will be explained. When the camera 100 is pushed further downward in the Y-axis direction from the state illustrated in FIG. 19D, the lock member 774 rotates in the engagement direction (counterclockwise in FIG. 19E) around the hole 774b. At this time, the inclined surface 774d formed on the lower part of the lock claw portion 774a fully engages with the inclined portion 824a formed on the mount member 825. When the downward pressing force on the centering pin 752 in the Y-axis direction exceeds the biasing force of the compression spring 7710, the lock member 775 rotates clockwise (away from the rotation restricting unit 772, as illustrated in FIG. 19E) around the hole 775b. As the lock member 775 rotates and the engagement with the rotation restricting unit 772 is released, the position restriction of the rotation restricting unit 772 in the Y-axis direction is also released. Therefore, the rotation restricting unit 772 is urged upward and moves in the Y-axis direction by the compression spring 7720. At this time, the contact portion 774c of the lock member 774 comes into contact with the contact surface 772c of the rotation restricting unit 772. As a result, the lock member 774 is prevented from rotating in the direction opposite to the engagement direction (clockwise in FIG. 19E).

Additionally, referring to FIG. 19E, the method for releasing the lock between the camera 100 and the platform 750 will be explained. The lock member 774, which is securing the camera 100 to the platform 750, cannot retract in the direction opposite to the engagement direction (clockwise in FIG. 19E) due to the rotation restricting unit 772, which is urged upward in the Y-axis direction. To release the lock, the operation portion 772d, formed as a pair with the rotation restricting unit 772, can be gripped by hand and moved downward in the Y-axis direction, disengaging the contact between the contact surface 772c and the lock member 774, allowing it to rotate. Once the engagement between the contact surface 772c and the contact portion 774c is released, the camera 100 can be easily lifted upward in the Y-axis direction and removed from the platform 750.

In other words, the user can simply place the camera 100 on the platform 750 and move it downward in the Y-axis direction to achieve a mechanically locked state through the lock mechanism 756. This allows for attachment without the need for bothersome actions like turning screws, as required with traditional tripod accessories.

While the disclosure has described example embodiments, it is to be understood that some embodiments are not limited to the disclosed embodiments. The scope of the following claims is to be accorded the broadest interpretation so as to encompass all such modifications and equivalent structures and functions.

According to the present disclosure, it is possible to provide an electronic apparatus with a space-saving structure that allows easy attachment and detachment of an accessory.

This application claims priority to Japanese Patent Application No. 2023-197198, which was filed on Nov. 21, 2023, and which is hereby incorporated by reference herein in its entirety.

What is claimed is:

1. An electronic apparatus comprising:
a tightening member including a first screw engagement portion and a first lock portion;
wherein the electronic apparatus is configured to allow for attachment and detachment of an accessory apparatus, which includes a rotation locking member having a second lock portion that rotates around a central axis of the tightening member and that engages with the first lock portion, and
wherein the tightening member is positioned coaxially with the first screw engagement portion and is provided outside the first screw engagement portion but inside the electronic apparatus.

2. The electronic apparatus according to claim 1, further comprising:
an exterior member that forms part of an appearance surface of the electronic apparatus; and
a mount member that is fixed to the exterior member,
wherein the first screw engagement portion is formed on the exterior member, and
wherein the first lock portion is formed by extending from the mount member toward a center of the first screw engagement portion.

3. The electronic apparatus according to claim 1, further comprising a screw engagement member on which the first screw engagement portion is formed,
wherein the first lock portion is formed by extending from the screw engagement member toward a position outside a center of the first screw engagement portion.

4. An accessory apparatus that is attachable to and detachable from an electronic apparatus including a tightening member having a first screw engagement portion and a first lock portion, the accessory apparatus comprising a rotation locking member;
wherein the tightening member is positioned coaxially with the first screw engagement portion and is provided outside the first screw engagement portion but inside the electronic apparatus, and
wherein the rotation locking member includes a second lock portion that rotates around a central axis of the tightening member and that engages with the first lock portion.

5. The accessory apparatus according to claim 4, further comprising:
a platform on which the electronic apparatus is mounted; and
a centering pin that is arranged around a rotation axis of the rotation locking member,
wherein the centering pin is movable in a direction parallel to the rotation axis relative to the platform and is urged in a protruding direction.

6. The accessory apparatus according to claim 5, further comprising a rotation operating member that is rotatably held on the platform,
wherein the centering pin includes a second screw engagement portion that is screwed with the first screw engagement portion, which is provided on a tip protruded from the platform, and is held to rotate integrally with the rotation operating member.

7. The accessory apparatus according to claim 5, further comprising a pushpin,
wherein the electronic apparatus includes a hole portion that is formed on the same surface as the tightening member and outside an outer shape of the tightening member, and
wherein the pushpin is urged in the protruding direction at a first position to be movable in a direction parallel to the rotation axis relative to the platform before the accessory apparatus is mounted to the electronic apparatus, and moves to a second position by being fitted into the hole portion and being pressing down after the accessory apparatus is mounted to the electronic apparatus.

8. The accessory apparatus according to claim 7,
wherein the pushpin includes a convex portion inside the platform,
wherein the convex portion extends in a direction orthogonal to a direction in which the pushpin moves back and forth, and towards a center of the rotation locking member, and engages with a concave portion of the rotation locking member to restrict rotation of the rotation locking member, and
wherein in the direction where the pushpin moves back and forth, an engagement amount between the convex portion and the concave portion in a protruding state is less than an amount of movement from the first position to the second position.

9. The accessory apparatus according to claim 8, wherein the rotation locking member is urged in a direction of engaging with the first lock portion.

10. The accessory apparatus according to claim 9, further comprising a release member that is rotatably held on the platform and moves the rotation locking member from a locked position, where the rotation locking member engages with the first lock portion, to an unlocked position, where the rotation locking member does not engage with the first lock portion,
wherein an amount by which the release member protrudes from a side of the platform when the rotation locking member is in the unlocked position is greater than an amount by which the release member protrudes from the side of the platform when the rotation locking member is in the locked position.

11. The accessory apparatus according to claim 5, further comprising a magnet holder that fixes a magnet,
wherein the electronic apparatus includes a magnetic body internally,
wherein the magnet holder is held to be movable back and forth in a direction parallel to the rotation axis relative to the platform,
wherein the magnet holder includes a convex portion inside the platform,
wherein the convex portion extends in a direction orthogonal to a direction in which the magnet holder moves back and forth, and towards a center of the rotation locking member, and engages with a concave portion of the rotation locking member to restrict rotation of the rotation locking member, and
wherein when the accessory apparatus is mounted on the electronic apparatus, the magnet holder moves in the direction parallel to the rotation axis due to the magnet, rotation restriction of the rotation locking member by the convex portion is released, and the rotation locking member rotates around the tightening member and engages with the first lock portion.

12. The accessory apparatus according to claim 5, further comprising:
a magnet holder that fixes a magnet; and
a pushpin,
wherein the electronic apparatus includes a hole portion formed on the same plane as the tightening member and outside an outer shape of the tightening member, and a magnetic body on an inner surface side of the electronic apparatus with respect to the hole portion,
wherein the magnet holder and the pushpin are held to be movable back and forth in a direction parallel to the rotation axis relative to the platform,
wherein the magnet holder and the pushpin include a convex portion inside the platform,
wherein the convex portion extends in a direction orthogonal to a direction in which the magnet holder and the pushpin move back and forth, and towards a center of the rotation locking member, and engages with a concave portion of the rotation locking member to restrict rotation of the rotation locking member, and
wherein when the accessory apparatus is mounted on the electronic apparatus, the magnet holder moves due to the magnet, the pushpin fits into the hole portion and moves to a second position, rotation restriction of the rotation locking member by the convex portion is released, and the rotation locking member rotates around the tightening member and engages with the first lock portion.

13. An electronic apparatus that is configured to allow for attachment and detachment of an accessory apparatus, the electronic apparatus comprising:
a first screw engagement portion; and
a lock portion that protrudes in a normal direction of the first screw engagement portion and that is formed concentrically with the first screw engagement portion,
wherein the lock portion engages with a locking member that is provided on the accessory apparatus and that is rotatable around an axis perpendicular to a central axis of the first screw engagement portion.

14. The electronic apparatus according to claim 13, further comprising a holder where the locking member is held,
wherein the holder is arranged outside the first screw engagement portion not to protrude beyond a bottom surface of the electronic apparatus.

15. An accessory apparatus that is attachable to and detachable from an electronic apparatus, which includes a first screw engagement portion and a lock portion that protrudes in a normal direction of the first screw engagement portion and that is formed concentrically with the first screw engagement portion, the accessory apparatus comprising a locking member that rotates around an axis perpendicular to a central axis of the first screw engagement portion and that engages with the engaging portion.

16. The accessory apparatus according to claim 15, further comprising:
a rotation restricting unit that is movable in a direction parallel to the central axis of the first screw engagement portion; and
a centering pin that is movable in the direction parallel to the central axis of the first screw engagement portion and that moves the accessory apparatus toward a side of the first screw engagement portion,
wherein the rotation restricting unit moves according to movement of the centering pin in a direction toward the electronic apparatus, and
wherein the locking member transits between a first state where rotation is allowed and a second state where the rotation is restricted by the rotation restricting unit.

17. The accessory apparatus according to claim 16, wherein the rotation restricting unit is held within the accessory apparatus to be movable in a direction toward the electronic apparatus, and does not intrude into an interior of the electronic apparatus.
